(19) United States
(12) Patent Application Publication
(10) Pub. No.: US 2025/0347404 A1
(43) Pub. Date: Nov. 13, 2025

(54) LOW VOLTAGE RGBW LED MINI STRAND AND SYSTEM

(71) Applicant: Intellect Holdings, LLC, Riverton, UT (US)

(72) Inventors: Drew Buck, West Jordan, UT (US); Sean Matz, Riverton, UT (US); Dan Oakeson, West Jordan, UT (US)

(21) Appl. No.: 19/200,619

(22) Filed: May 6, 2025

Related U.S. Application Data
(60) Provisional application No. 63/643,603, filed on May 7, 2024.

(51) Int. Cl. F21V 23/02; F21S 4/10; F21V 23/00; F21V 23/06; F21W 131/10; F21Y 115/10; H05B 45/20; H05B 45/38; H05B 47/155; H05B 47/175

(52) U.S. Cl. CPC F21V 23/023; F21S 4/10; F21V 23/001; F21V 23/008; F21V 23/06; H05B 45/20; H05B 45/38; H05B 47/155; H05B 47/175; F21W 2131/10; F21Y 2115/10

(57) ABSTRACT

This disclosure relates generally to low-voltage RGBW holiday lighting systems for use in landscape and outdoor lighting installations. In various aspects, a landscape lighting system includes a plurality of low-voltage red-green-blue-warm white (RGBW) lights, a transformer for providing an initial power level, and a plurality of boosters electrically connected to the transformer. The plurality of boosters are for stepping up the initial power level of the transformer to a power level for the plurality of low-voltage RGBW lights, where each of the plurality of boosters are to be installed at a landscape element (e.g., trees, bushes, gazebos, hardscapes, landscape structures, houses, etc.). The system further includes a plurality of connectors for connecting the plurality of boosters to the transformer and for connecting the plurality of boosters to the plurality of low-voltage RGBW lights.

### CLAIM FOR PRIORITY

This application claims the benefit of and priority to U.S. Provisional Application No. 63/643,603 filed on May 7, 2024 and titled “LOW VOLTAGE RGBW LED MINI STRAND AND SYSTEM,” the entire contents of which are herein incorporated by reference.

### TECHNICAL FIELD

This disclosure relates generally to low-voltage lighting systems and, more specifically, low-voltage RGBW lighting systems for use in landscape and outdoor lighting installations, such as holiday lighting systems.

### SUMMARY

Disclosed are systems, devices, and/or methods of use thereof regarding low-voltage RGBW lighting systems for use in landscape and outdoor lighting installations, such as holiday lighting systems. In various aspects, a landscape lighting system includes a plurality of low-voltage red-green-blue-warm white (RGBW) lights and a 11-15 volt AC (V AC) transformer for providing an initial power level. The system also includes a plurality of boosters electrically connected to the transformer and for stepping up the initial power level of the 11-15V AC transformer to a higher power level of 30-50 volts DC (V DC) for the plurality of low-voltage RGBW lights, where each of the plurality of boosters are to be installed at a landscape element. The system further includes a plurality of connectors for connecting the plurality of 30-50 volt boosters to the 11-15V AC transformer and for connecting the plurality of 30-50V DC boosters to the plurality of low-voltage RGBW lights.

In various aspects, a landscape lighting system includes a plurality of light strands, with each light strand having a plurality of low-voltage RGBW lights. The system also includes a transformer for providing an initial power level, and a plurality of boosters electrically connected to the transformer and for stepping up the initial power level of the transformer to a power level for the plurality of light strands. Each of the plurality of boosters are installed at a landscape element. The system further includes a controller for providing color instructions to the plurality of boosters for each of the plurality of light strands.

In various aspects, a method of lighting landscape elements includes connecting a transformer to a power source, where the transformer is for providing an initial power level ranging from about 11 Voltage Alternating Current (V AC) to 15V AC. The method also includes connecting a plurality of boosters to the transformer and stepping up the initial power level to an elevated, low-voltage power level. The elevated, low-voltage power level may range from about 30V DC to about 50V DC. The method may also include powering one or more low-voltage RGBW light sets with the elevated, low-voltage power level and individually controlling a color for each of the plurality of low-voltage RGBW light sets.

Other aspects of the disclosed subject matter, as well as features and advantages of various aspects of the disclosed subject matter, should be apparent to those of ordinary skill in the art through consideration of the ensuing description, the accompanying drawings, and the appended claims.

### BRIEF DESCRIPTION OF THE DRAWINGS

In the drawings:

FIG. 1 illustrates a landscape lighting system installed at a residence;

FIG. 2 illustrates a close-up view of a landscape element having a plurality of light strands and at least one booster installed from the lighting system of FIG. 1;

FIG. 3A illustrates one embodiment of a booster from the lighting system of FIG. 1;

FIG. 3B illustrates another embodiment of a booster from the lighting system of FIG. 1;

FIGS. 4A to 4C illustrate connections of the booster of FIG. 3;

FIG. 5 illustrates one embodiment of a light strand for use in the lighting system of FIG. 1;

FIG. 6 illustrates another embodiment of a light strand for use in the lighting system of FIG. 1;

FIGS. 7A through 7D illustrate various connectors for use in the lighting system of FIG. 1;

FIG. 8 schematically illustrates a block diagram of the booster of FIG. 3;

FIG. 9 schematically illustrates a system of the disclosure;

FIG. 10 is a flowchart for an example method according to the present disclosure; and

FIG. 11 is a flowchart for another example method according to the present disclosure.

### DETAILED DESCRIPTION

Conventional lighting systems utilize high-voltage cables and lights to provide outdoor holiday and other lighting. For example, residential holiday lighting systems typically utilize 120V systems, where each element of the system is powered using the 120V. However, installation of 120V cabling is challenging as there are stricter safety regulations and a need for a protective conduit. Generally, the protective conduit and the cable must be buried at least 18 inches underground to safeguard against physical damage and ensure safety of the system. Extension cords may also be used on the ground surface, creating shock risks and tripping hazards.

Unfortunately, installation of 120V cabling is time and labor-intensive, as the cables and the conduit must be buried so deep. The intensity of the installation process is also expensive due to the deeper excavation needed and the potential for encountering underground utilities. Installation of conventional, high-voltage lighting systems requires licensed electricians, further adding to the cost and time of installation.

Additionally, conventional lighting systems frequently trip GFCI outlets in wet conditions (e.g., rain, snow, etc.) due to electrical leakage of the system. Current solutions to this problem involve covering the outlet and any plugs with a plastic box. The plastic box, however, is prone to breakage (e.g., cracking) under wet and extreme conditions, making the solution only temporary.

Landscapers, who frequently undertake holiday lighting projects to maintain off-season activity and profitability, are intimately familiar with both landscape and Christmas lighting setups. This familiarity positions them as ideal purchasers or distributors for the innovative system. The immunity of disclosed lighting systems to moisture-induced GFCI tripping will be particularly appealing to landscapers, contractors, and homeowners, addressing a major issue faced in installation and maintenance of landscape holiday lighting. Their comfort with installing landscape lighting cables and 12V AC transformers aligns perfectly with the installation needs of disclosed lighting systems, promising a seamless integration into their landscape lighting services.

This comprehensive approach, incorporating low-voltage RGBW lighting within a landscape lighting framework, aims to redefine Christmas and other holiday lighting by offering aesthetic versatility, unmatched reliability, and ease of installation. The strategic distribution through the green industry (e.g., landscapers) not only leverages an existing network but also leverages landscapers' expertise and client relationships, establishing the system as the premier choice in the holiday lighting market.

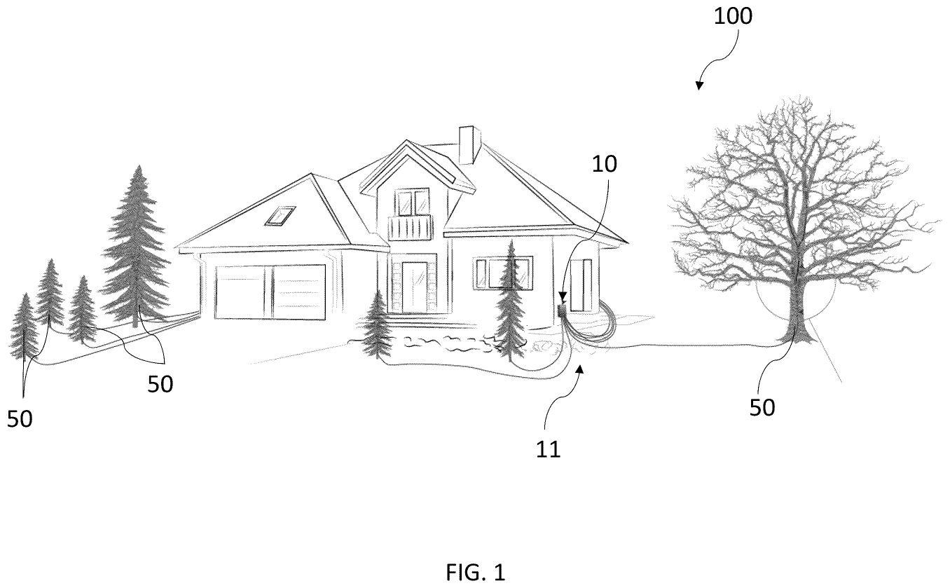

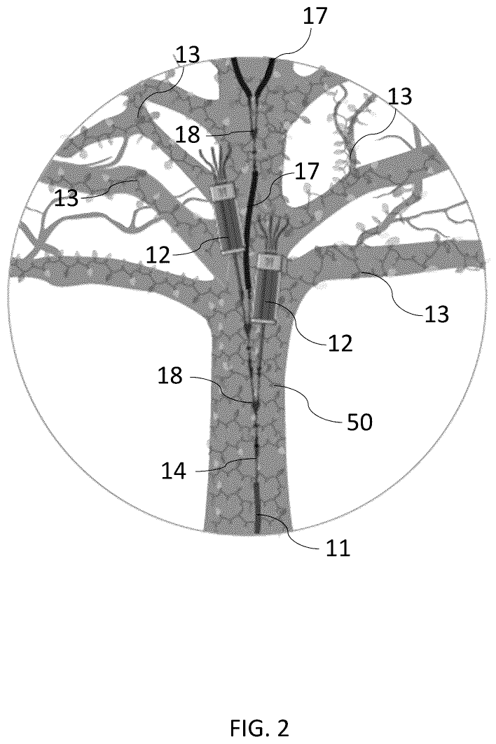

FIGS. 1 and 2 illustrate a landscape lighting system 100 installed at a residence and a close-up view of a landscape element having installed a plurality of elements of the low-voltage RGBW lighting system of FIG. 1. The landscape lighting system 100 includes a transformer 10 for connection to an exterior or outdoor outlet of the residence and a plurality of landscape cables 11 for connecting the transformer 10 to lighting elements installed in landscape elements 50. The exterior outlet may be a standard, GFCI 120V outlet. The transformer 10 may provide an initial power level of about 11V AC to about 15V AC. The landscape cables 11 may be 12-2 American wire gauge (Awg) (or 14-2 Awg, 10-2 Awg, etc.) landscape lighting direct burial cables and may extend from the transformer 10 to each landscape element 50 (e.g., trees, bushes, outdoor structures and houses, etc.) designated for decoration. Ideally, one dedicated cable per tree is installed for reliable power distribution.

Installed at each landscape element 50 is a booster 12 that may be electrically connected to a plurality of light strands 13. The booster 12 may be for stepping up, elevating, and/or converting the initial power level provided by the transformer 10 to an elevated, low-voltage level for powering individual light strands 13. For example, the booster 12 may step up and convert the initial power level from about 11-15V AC to about 30-50V DC.

Each of the plurality of light strands 13 may be powered by an elevated, low-voltage power level ranging from about 30V DC to about 50V DC. The low-voltage power required for the individual light strands 13 substantially increases the installation safety of the landscape lighting system 100, as high-voltage elements do not need to be installed and high-voltage cables do not need to be buried deep beneath the ground. Additionally, the low-voltage lights substantially lower the risk of tripping the GFCI outlet the transformer 10 is connected to. Specifically, the reduced voltage decreases the likelihood of electrical current bridging through water, offering more dependable lighting in adverse weather conditions and decreasing the likelihood of tripping the outlet.

Conventional lighting systems that utilize 120V AC components are limited to installation at locations where there is 120V AC power available. In contrast, the landscape lighting system 100 can be utilized in any location where there is a 12V AC outlet, a 12V AC wire, or another source of 12V AC power. Specifically, the boosters 12 step up and convert the 12V AC power to 30-50V DC in order to power the low-voltage light strands 13. The landscape lighting system 100 is capable of powering the low-voltage lights while still providing a bright light and allowing more light strands 13 to be incorporated into the system 100.

Each of the plurality of light strands 13 may include a plurality of red-green-blue-warm white lights (e.g., light-emitting diodes, LEDs) spaced a distance apart. In some embodiments, the light strands 13 include 40 to 70 lights spaced about 3 to 14 inches apart from each other, for a total strand length of about 20 to about 45 feet. For example, the light strands 13 may include 48 lights spaced about 6 inches apart from each other. Alternatively, the light strands 13 may include 50 lights spaced about 4 inches apart from each other. The light strands 13 may include 54 lights spaced about 6 inches apart from each other. The light strands may include 70 lights spaced about 3 inches from each other; or 70 lights spaced about 6 inches from each other. In other configurations, any desired length of light strand 13 may be used, any desired number of lights may be used, and any desired spacing between the lights (whether the same spacing between each light or different spacing between different lights) may be used.

In some embodiments, an in-line amplifier (not illustrated) may be employed in longer setups to ensure data signal integrity. The lights of the light strands 13 may be attached to a brown or other neutral colored wire, thereby substantially hiding the light strands 13 when they are installed in a landscape element 50. In some embodiments, the lights of the light strands 13 are spaced about 12 inches from each other and are incorporated into a 500 foot reel, such as for application to a roofline or other building structure.

The light strands 13 may include any number of lights spaced at any distance apart appropriate for the particular application, such as installation of the light strands 13 along a roofline, around windows, or within landscape elements 50 (e.g., bushes, trees, rocks, etc.). In some embodiments, the lights are disposed on the wires or cables of the light strands 13 to impart a particular profile, such as a flat or low profile for light strands 13 that are installed on rooflines, around windows, and/or in a landscape element 50. In other embodiments, bulbs or casings (e.g., C-7 bulbs, C-9 bulbs, etc.) for the lights may be incorporated into the light strands 13, such that the bulbs extend outwardly from the light strands 13 and are visible when installed along a roofline, around windows, and/or in a landscape element 50.

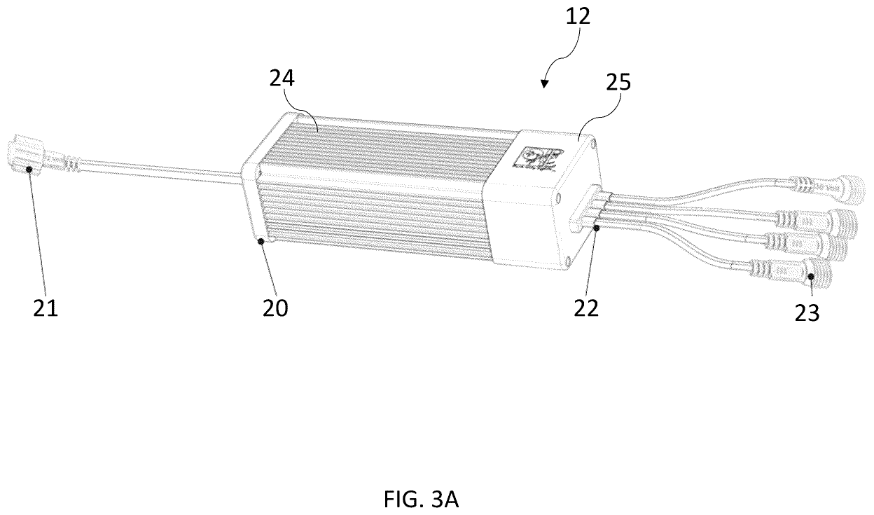

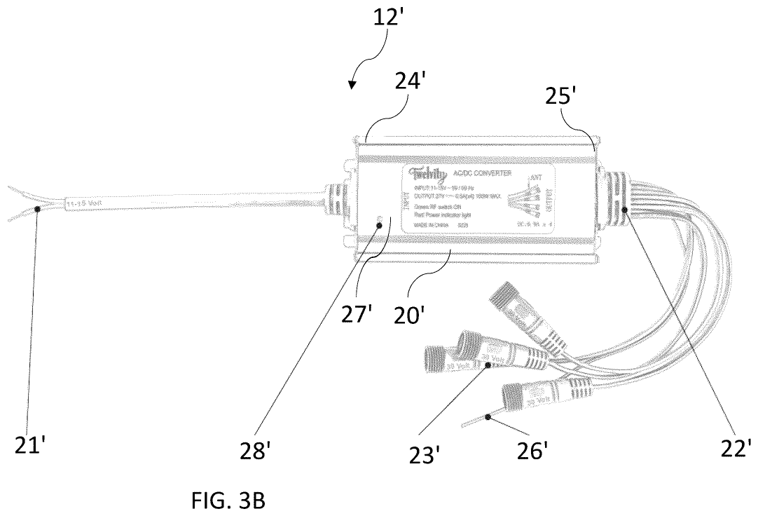

Referring to FIG. 2, the boosters 12 are connected to the buried landscape cables 11 via connectors 14. The connectors 14 may be 12V AC connectors, such as 12V AC coaxial connectors and/or 12V AC coaxial landscape wire connectors, as appropriate. The connectors 14 may then be connected to a coaxial splitter 18. The coaxial splitter 18 may be a 12V AC coaxial Y splitter. The coaxial splitter 18 may be connected to one or more boosters 12, an extension cable 17 (e.g., a 12V AC extension cord), and/or another connector 14. The boosters 12 are electrically connected to the transformer 10 through the connectors 14 and the coaxial splitters 18. Each of the installed cables 11, 17, connectors 14, and splitters 18 may be 12V AC, increasing the safety and ease of installation of the landscape lighting system 100. The plurality of light strands 13 are connected to, powered by, and controlled by the boosters 12. As discussed more with respect to FIG. 3, each booster 12 may be connected to twenty-four (24) individual light strands 13, as each leg of the booster 12 may be connected to six (6) sets of light strands 13.

Extension cables 17 may be connected to a first splitter 18 at one end and a second splitter 18 at an opposing end of the extension cable 17, thereby allowing boosters 12 to be installed and positioned within an entire height of the landscape element 50. Depending on the size and shape of the landscape element 50, a plurality of boosters 12 may be installed at the landscape element 50 to adequately power and control the plurality of light strands 13 installed at the landscape element 50.

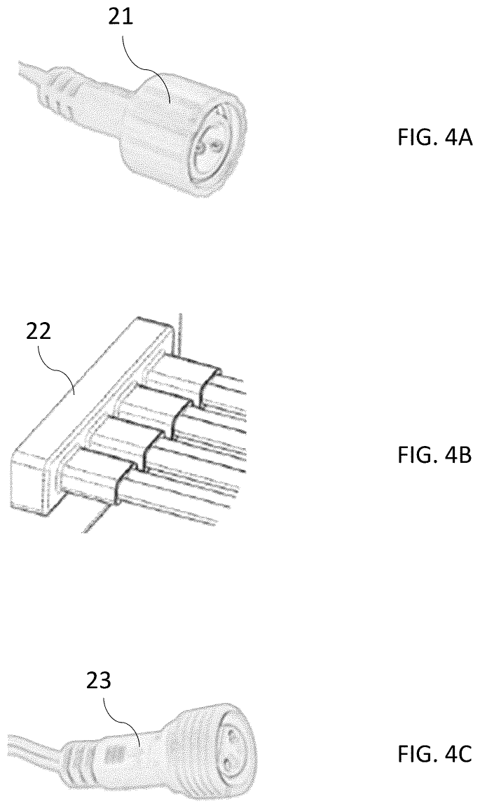

FIG. 3A illustrates one embodiment of a booster 12 from the lighting system 100 of FIG. 1. Each booster 12 includes a housing 20 having a first connection 21 at a first end 24 of the housing 20 and a second connection 22 at a second, opposing end 25 of the housing 20. Referring briefly to FIG. 4A, the first connection 21 may be a coaxial male connection 21 for coupling the booster 12 to the landscape cabling 11 (e.g., directly or through a connector 14). Additionally, and/or alternatively, the first connection 21 may include any appropriate connection for coupling the booster 12 to the landscape cabling 11. Referring to FIG. 4B, the second connection 22 may be a splitter, such as a 4-way splitter, for connecting the booster 12 to a plurality of light strands 13. In such embodiments, each connection 22 of the splitter may terminate in a female coaxial connection 23 (see FIG. 4C). The female coaxial connections 23 may be for coupling the booster 12 (i.e., the splitter connection 22) to a plurality of light strands 13. For example, twenty-four (24) individual light strands 13 may be coupled to the booster 12 through the 4-way splitter connection 22, with each connection 23 capable of connecting to up to six (6) individual light strands 13. Additionally, and/or alternatively, the connections 23 may include any appropriate connection for coupling the booster 12 to the light strands 13.

FIG. 3B illustrates another embodiment of a booster 12′ from the lighting system 100 of FIG. 1. Booster 12′ is substantially similar to booster 12 of FIG. 3A, so similar reference numbers will be used to indicate similar features. Each booster 12′ includes a housing 20′ having a first connection 21′ at a first end 24′ of the housing 20′ and a second connection 22′ at a second, opposing end 25′ of the housing 20′. Similar to the connections 21, 22 of the booster 12 from FIG. 3A, the first connection 21′ may be a coaxial male connection 21′ for coupling the booster 12′ to the landscape cabling 11′ (e.g., directly or through a connector 14). Additionally, and/or alternatively, the first connection 21′ may include any appropriate connection for coupling the booster 12′ to the landscape cabling 11′. Also similar, the second connection 22′ may be a splitter, such as a 4-way splitter, for connecting the booster 12′ to a plurality of light strands 13. In such embodiments, each connection 22′ of the splitter may terminate in a female coaxial connection 23′. The female coaxial connections 23′ may be for coupling the booster 12′ (i.e., the splitter connection 22′) to a plurality of light strands 13. For example, twenty-four (24) individual light strands 13 may be coupled to the booster 12 through the 4-way splitter connection 22′, with each connection 23′ capable of connecting to up to six (6) individual light strands 13.

Additionally, and/or alternatively, the connections 23′ may include any appropriate connection for coupling the booster 12′ to the light strands 13. Still additionally, the connections 23′ may include antennas 26′ or other communications mechanisms for facilitating communication between the connections 23′ and a controller, such as a remote controller. The booster 12′ may also include an actuator 27′ for locking the booster 12′ (e.g., locking the settings provided by the booster 12′ to the light strands 13) and an indicator light 28′ to indicate the booster 12′ is operational.

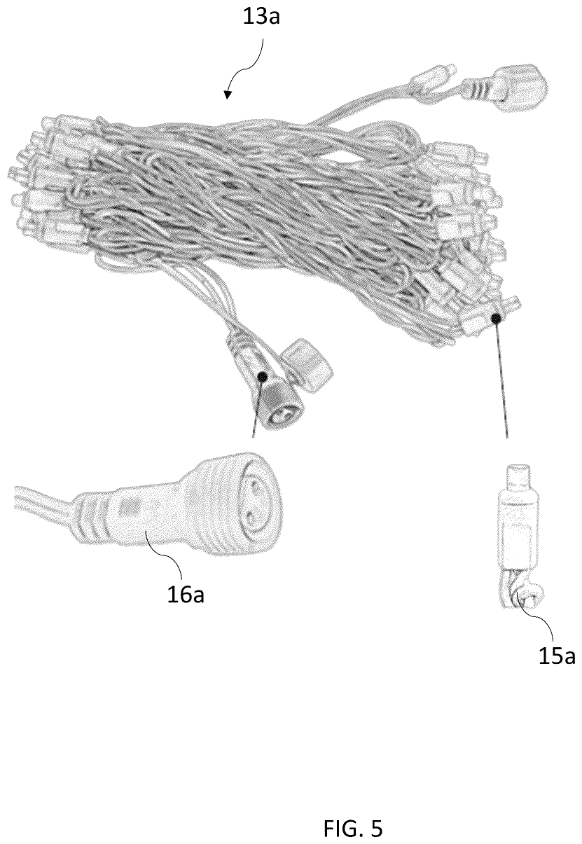

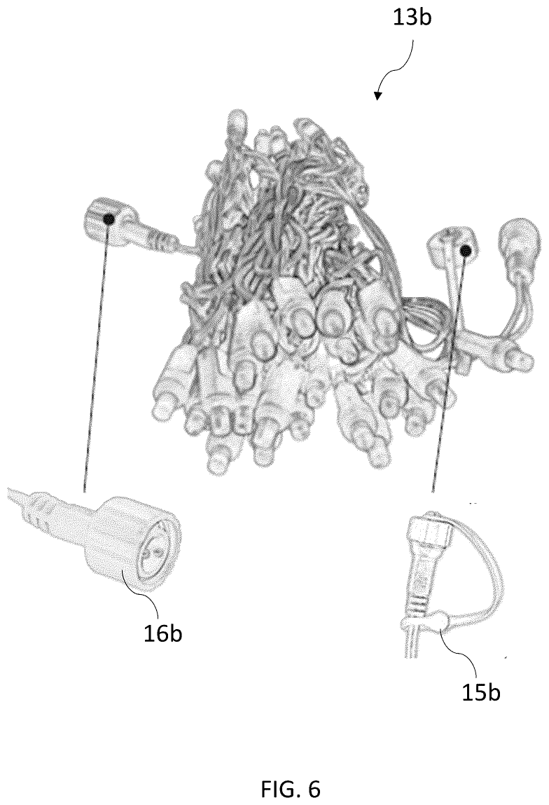

FIGS. 5 and 6 illustrate embodiments of light strands 13 for use in the lighting system 100 of FIG. 1. Specifically, FIG. 5 illustrates an embodiment of a light strand 13a having LEDs 15a and a female coaxial connection 16a. The LEDs 15a may be 5 mm concave or convex LEDs 15a. In some embodiments, the LEDs may include c-7 style bulbs (not illustrated). The light strands 13 may include any combination of LED types, as appropriate for use in landscape and residential lighting systems. FIG. 6 illustrates another embodiment of a light strand 13b having LEDs 15b with an end cap and a male coaxial connection 16b. The light strands 13 include LEDs powered at low-voltage power of 30-50VDC.

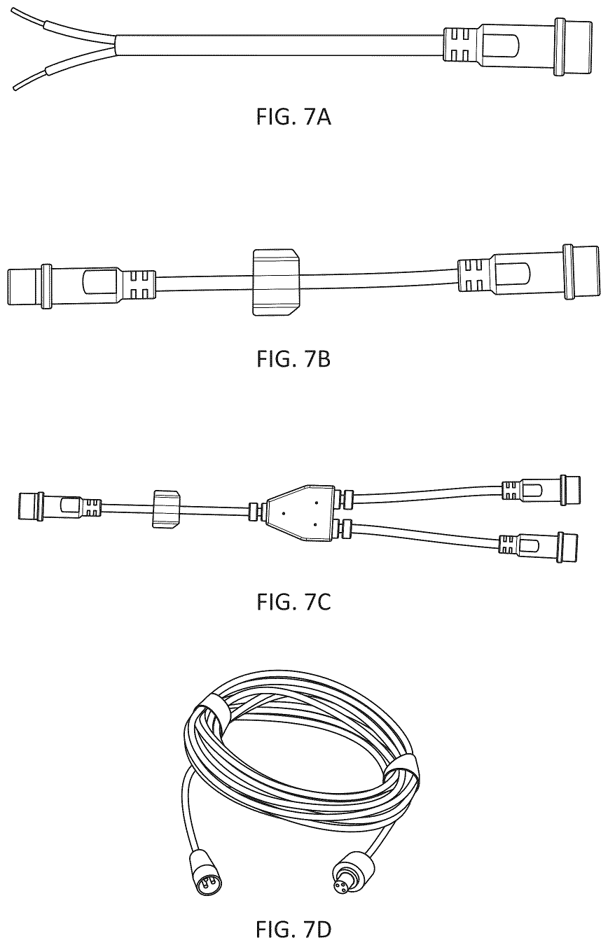

FIGS. 7A to 7D illustrate various connectors for use in the lighting system 100 of FIG. 1. FIG. 7A illustrates a 12V AC coaxial landscape wire connector for connecting the landscape cabling 11 to a booster 12, such as through a coaxial connector. FIG. 7B illustrates the 12V AC coaxial connector for connecting the landscape cabling 11 to a coaxial splitter, such as the 12V AC coaxial Y splitter illustrated in FIG. 7C. FIG. 7D illustrates a 12V AC extension cord for facilitating the installation of boosters 12 within landscape elements 50, such as trees.

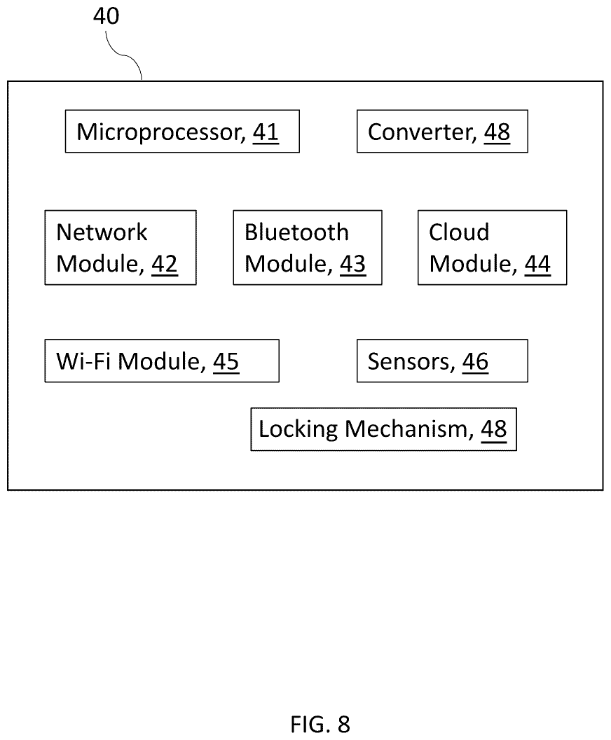

FIG. 8 schematically illustrates a block diagram 40 of the booster 12 of FIG. 3A or the booster 12′ of FIG. 3B. Incorporated within the boosters 12, 12′ is a controller or microprocessor 41 that handles data signals and power output, facilitating the customization of light colors, patterns, and themes for the landscape lighting system 100 and/or individual landscape elements 50. Additionally, incorporated within the boosters 12, 12′ are various modules such as a network module 42, a Bluetooth module 43, a cloud module 44, and a Wi-Fi module 45. The various modules may facilitate communication of the boosters 12, 12′ to a controller, such as a local controller or a remote controller (e.g., a software application executed by a mobile device such as a phone or tablet). The controller may provide instructions, such as light colors, patterns, themes, timers, etc., to the microprocessor 41 which may then control individual light strands 13 according to the instructions.

Further, the boosters 12, 12′ may incorporate one or more converters 48 for stepping up the initial power level provided by the transformer 10 and converting the alternating current from the transformer 10 to a direct current for the light strands 13. Still further, the boosters 12 may incorporate one or more sensors 46 for detecting conditions about the landscape lighting system 100 (e.g., weather conditions, etc.) and for facilitating control of individual light strands 13. Additionally, the boosters 12, 12′ may include a locking mechanism 48 for locking the settings of the light strands 13 and preventing unauthorized adjustment or access to the controller or microprocessor 41. The locking mechanism 48 may be activated by actuation of an actuator 27′ on the booster 12′. The locking mechanism 48 may bot lock the settings of the landscape lighting system 100 and provide a security mechanism for the landscape lighting system 100.

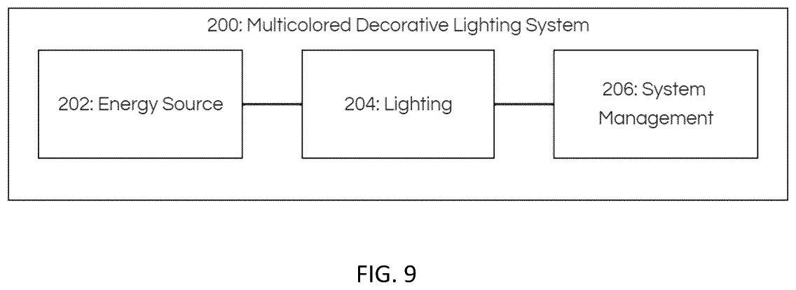

FIG. 9 schematically illustrates a lighting system 200 designed for festive lighting, offering versatility, safety, and convenience through advanced design and control features. The system includes an energy source 202, such as a transformer, which powers the system. Integrated into the energy source 202 is a power converter or power conversion module, which elevates the voltage to the required level for the lighting 204 component, consisting of a series of bulbs providing customizable colors. System management 206 oversees operation and security.

In some embodiments, the energy source 202 is a 11-15V AC landscape lighting transformer, serving as the primary power supply. This transformer is selected for its compatibility with standard landscape lighting infrastructure, facilitating integration into existing setups. The power conversion is a sub-component that takes the low voltage from the Energy Source 202 and elevates it to a range of 30-50V DC. This conversion is executed by a controller/booster, designed to handle the voltage transformation while maintaining safety standards. The higher voltage is necessary to power the lighting 204, which is a 30-50V DC RGBW mini LED strand with 48 bulbs spaced 6 inches apart.

System management 206 may be responsible for the operational control and customization of the lighting. In some embodiments, system management 206 may be incorporated into a booster, such as boosters 12, 12′ (e.g., as part of the controller or microprocessor 41, etc.). It includes a control unit and may also include a locking mechanism. The control unit allows for individual color customization of each light strand through a remote control device or a mobile application. The control unit's locking mechanism ensures that settings are securely maintained, preventing unauthorized adjustments. Together, these components work in harmony to deliver a customizable and efficient decorative lighting solution. In some configurations, the locking mechanism may be an actuator located on the control unit that can be physically actuated to lock the settings.

The energy source 202 is a component of the RGBW lights, tasked with providing power for the system. It operates by utilizing a central power source, which is a 11-15V AC landscape lighting transformer. This transformer is selected for its compatibility with outdoor lighting systems and provides a stable voltage level for the operation of the lights.

Within the energy source 202, the power conversion may be a sub-component responsible for transforming the lower voltage from the central power source to a higher voltage range of 30-50V DC. This step-up in voltage is achieved through a controller/booster, which is designed to adjust the voltage to the required level for the light strand. The controller/booster contains electronic circuitry, including transformers and rectifiers, to manage the voltage conversion process. This ensures that the light strand receives the correct voltage for operation.

The higher voltage output from the power conversion is then supplied to the light strand or lighting component 204, which consists of 48 bulbs spaced 6 inches apart, which are responsible for the multicolored illumination. The system is designed to function under various outdoor conditions, providing consistent lighting effects. The voltage range of 30-50 volts is maintained to comply with low voltage regulations and to ensure the safety and reliability of the lighting system during use. This voltage increase is necessary to power the LED strand, which requires a higher voltage than what the landscape transformer outputs. The bulbs within the strand are capable of displaying a range of colors, enabled by the control unit that modulates the power supply to each bulb, allowing for color customization. The Lighting component 204 provides the visual output for the system.

The system management 206 component enables user interaction with the RGBW festive lights, enabling control and customization of lighting effects. It includes a control unit with a security feature and interfaces for remote operation. System management 206 can include control unit that incorporates a security feature and interfaces for remote operation. The control unit may be responsible for integrating a security feature that prevents unauthorized access or tampering, ensuring that only those with the correct authorization can alter the lighting settings. The control unit also includes all communication protocols necessary to allow the system to communicate with other aspects of the system, including to receive inputs from a remote controller, a smartphone app, etc., as well as to send outputs to such devices.

The control unit connected to the lighting component 204 is equipped with a locking mechanism, providing security by preventing unauthorized adjustments. Users can control the lighting system through a remote control device or a mobile application, which interfaces with the control unit to select and modify the color output and lighting patterns. This user interface is designed for straightforward interaction, enabling users to manage the lighting display according to their preferences.

The control unit also allows individual color customization of each light strand and individual bulbs, enabling users to select and modify the color output of the lights to fit various themes or occasions. The customization process is managed through a remote control device or a mobile application, providing an interface for system operation. These control interfaces communicate with the control unit, sending commands that adjust the light colors as desired by the user.

The operation involves the user selecting their preferred settings via the remote or mobile application. The control unit receives these commands and implements the changes, activating the locking mechanism on the control box for each tree when necessary. This ensures that the settings are securely applied and maintained, providing a stable lighting experience. The integration of these components allows for a managed and customizable lighting system.

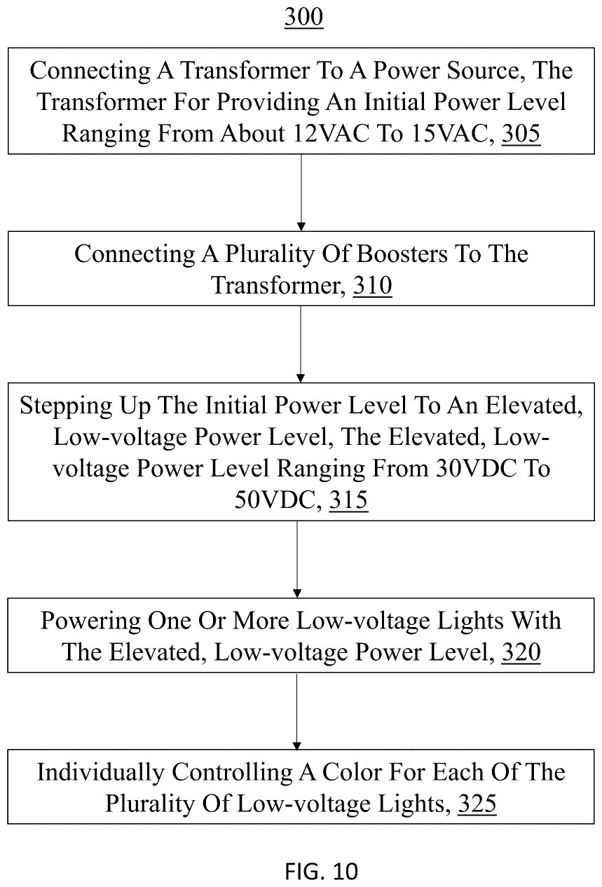

FIG. 10 is a flowchart for an example method 300 of lighting landscape elements, according to the present disclosure. The method 300 may include connecting a transformer to a power source, the transformer for providing an initial power level ranging from about 11V AC to 15V AC, at 305. The transformer may be transformer 10 from the lighting system 100 of FIG. 1. The power source may be a standard GFCI 120V outlet of a residential structure, such as a home. The method 300 may also include connecting a plurality of boosters to the transformer, at 310. The boosters may be the boosters 12 of FIGS. 2 to 3, which may be connected to a plurality of light strands 13. The light strands 13 incorporate a plurality of RGBW lights and are powered at low-voltage power levels.

The method 300 may further include stepping up the initial power level to an elevated, low-voltage power level, the elevated, low-voltage power level ranging from 30V DC to 50 VDC, at 315. For example, the booster may step up and convert an initial power level of about 12V AC to an elevated, low-voltage power level of about 30V DC. The RGBW light strands may be powered at the elevated, low-voltage power level of about 30V DC. Stepping up the initial power level to an elevated, low-voltage power level may include receiving an initial power level of about 11-15V AC, stepping up the 11-15V AC to a range of 30-50V DC, and providing 30-50V DC power to one or more low-voltage lights.

Still further, the method 300 may include powering one or more low-voltage lights with the elevated, low-voltage power level, at 320, and individually controlling a color for each of the plurality of low-voltage lights, at 325. A color of individual bulbs on the light strands 13 may be controlled by the boosters 12. For example, it is possible to control each individual bulb through its specific address (e.g., an IP address) and it is possible to tie into and control each individual bulb through DMX controls.

Additionally, controlling a color of individual lights and/or light strands 13 may provide a range of whites, such as cool whites to warm whites. Individually controlling a color for each of the plurality of low-voltage lights may include selecting a desired color for each of the plurality of low-voltage lights, sending instructions corresponding to the desired color to at least one of the plurality of boosters, and sending instructions corresponding to the desired color to at least one of the plurality of low-voltage lights.

In some embodiments, the method 300 may additionally include installing the plurality of low-voltage lights in a plurality of landscape elements, such as trees and bushes. The method 300 may also include installing the plurality of boosters in a plurality of landscape elements.

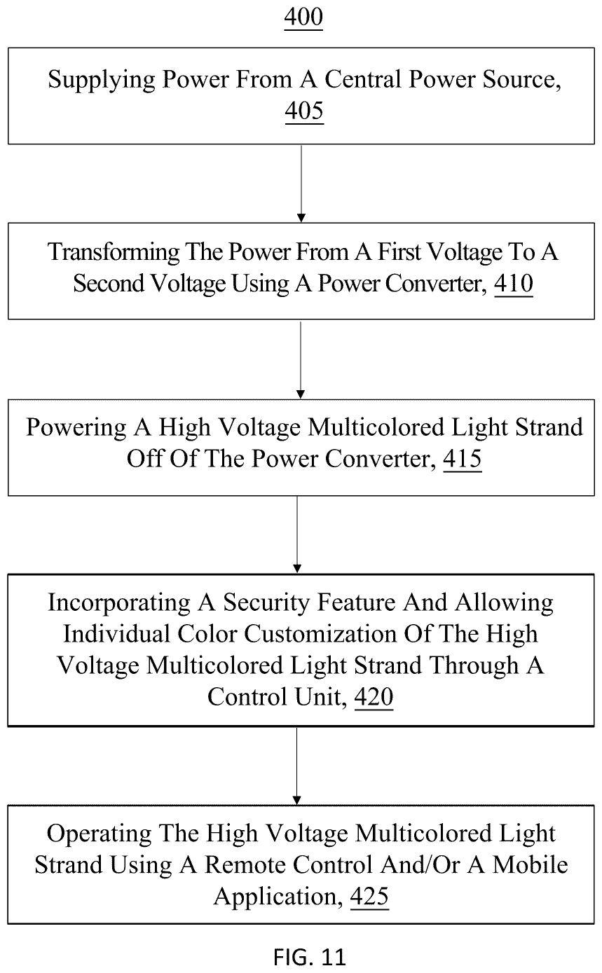

FIG. 11 is a flowchart for an example method 400 of providing multicolored decorative lighting, such as incorporating multicolored decorative lighting into a landscape lighting system. The method 400 may include supplying power from a central power source, at 405, and transforming the power from a first voltage to a second voltage using a power convert, at 410, where the second voltage is greater than the first voltage. The method 400 may also include powering a high voltage multicolored light strand off of the power converter, at 415, with the high voltage multicolored light strand including a plurality of light sources positioned at regular intervals. Additionally, the method 400 may include incorporating a security feature and allowing individual color customization of the high voltage multicolored light strand through a control unit connected to the high voltage multicolored light strand. Further, the method may include operating the high-voltage multicolored light strand using a remote control device and/or a mobile application.

The central power source may be a 11-15V AC landscape lighting transformer, which may be in connection with a standard GFCI 120V outlet (e.g., an exterior, weather-proof outlet, etc.). The power converter may be a controller or booster that converts the 11-15V AC to 30-50V DC. The high voltage multicolored light strand may be a 30-50V DC RGBW mini LED strand having 49 bulbs spaced approximately 6 inches apart. A control unit may include the security feature and an additional locking mechanism for each tree. The remote control device and/or the mobile application may allow users to manage the operation of the plurality of light sources.

The disclosed systems and methods are robust and capable of withstanding a range of weather conditions (e.g., rain, snow, heat, wind, etc.). Additionally, the disclosed systems are easy to install and maintain, have flexible installation timings (e.g., pre-wiring services), and straightforward installations under snowy conditions. Further, the 12V cabling can be installed with minimal excavation, reducing labor costs and the risk of utility disruption. The disclosed systems also decrease the need for extensive stores of inventory, as users of the system can choose any color, pattern, or theme from a single landscape lighting system, and add special effects to amplify the festive spirit for any holiday occasion.

### Additional Terms and Definitions

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It should also be noted that some of the embodiments disclosed herein may have been disclosed in relation to a particular landscape element (e.g., a tree) or structure (e.g., a house); however, other landscape elements (e.g., shrubs, bushes, etc.) and structures (e.g., gazebos, hardscapes, etc.) are also contemplated.

In one embodiment, the terms “about” and “approximately” refer to numerical parameters within 10% of the indicated range. The terms “a,” “an,” “the,” and similar referents used in the context of describing the embodiments of the present disclosure (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate the embodiments of the present disclosure and does not pose a limitation on the scope of the present disclosure. No language in the specification should be construed as indicating any non-claimed element essential to the practice of the embodiments of the present disclosure.

Groupings of alternative elements or embodiments disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Certain embodiments are described herein, including the best mode known to the author(s) of this disclosure for carrying out the embodiments disclosed herein. Of course, variations on these described embodiments will become apparent to those of ordinary skill in the art upon reading the foregoing description. The author(s) expects skilled artisans to employ such variations as appropriate, and the author(s) intends for the embodiments of the present disclosure to be practiced otherwise than specifically described herein. Accordingly, this disclosure includes all modifications and equivalents of the subject matter recited in the claims appended hereto as permitted by applicable law. Moreover, any combination of the above-described elements in all possible variations thereof is encompassed by the present disclosure unless otherwise indicated herein or otherwise clearly contradicted by context.

Specific embodiments disclosed herein may be further limited in the claims using consisting of or consisting essentially of language. When used in the claims, whether as filed or added per amendment, the transition term “consisting of” excludes any element, step, or ingredient not specified in the claims. The transition term “consisting essentially of” limits the scope of a claim to the specified materials or steps and those that do not materially affect the basic and novel characteristic(s). Embodiments of this disclosure so claimed are inherently or expressly described and enabled herein.

Although this disclosure provides many specifics, these should not be construed as limiting the scope of any of the claims that follow, but merely as providing illustrations of some embodiments of elements and features of the disclosed subject matter. Other embodiments of the disclosed subject matter, and of their elements and features, may be devised which do not depart from the spirit or scope of any of the claims. Features from different embodiments may be employed in combination. Accordingly, the scope of each claim is limited only by its plain language and the legal equivalents thereto.

What is claimed:

1. A landscape lighting system comprising:
a plurality of low-voltage RGBW lights;
a transformer for providing an initial power level, the transformer for connection to a GFCI outlet;
a plurality of boosters electrically connected to the transformer and for stepping up the initial power level provided by the transformer to a power level for the plurality of low-voltage RGBW lights, each of the plurality of boosters to be installed at a landscape element,
the plurality of boosters stepping up the initial power level from 11-15V AC to 30-50V DC as the power level for the plurality of low-voltage RGBW lights; and
a plurality of connectors for connecting the plurality of boosters to the transformer and for connecting the plurality of boosters to the plurality of low-voltage RGBW lights.

2. The landscape lighting system of claim 1, wherein the plurality of low-voltage RGBW lights comprise a plurality of strands where each strand of the plurality includes 48bulbs spaced apart from each other by a distance ranging from about 4 inches to about 6 inches.

3. The landscape lighting system of claim 2, wherein the distance is about 6 inches.

4. The landscape lighting system of claim 1, wherein the initial power level of the transformer is about 12V AC.

5. The landscape lighting system of claim 1, wherein the plurality of low-voltage RGBW lights are installed at a landscape element alongside at least one booster of the plurality of boosters.

6. The landscape lighting system of claim 1, wherein the power level for the plurality of low-voltage RGBW lights is about 30V DC.

7. The landscape lighting system of claim 1, wherein each of the plurality of boosters comprises a booster for stepping up the initial power level of the transformer to the power level for the plurality of low-voltage RGBW lights and a controller for controlling a color of the plurality of low-voltage RGBW lights.

8. The landscape lighting system of claim 7, further comprising a remote device for sending instructions to the controller of each of the plurality of boosters, the instructions comprising a color for the plurality of low-voltage RGBW lights.

9. The landscape lighting system of claim 1, further comprising a remote device for sending instructions to the plurality of boosters.

10. The landscape lighting system of claim 1, wherein the plurality of connectors comprise (i) a plurality of coaxial landscape wires to connect the transformer to each of the plurality of boosters and (ii) a plurality of coaxial connectors to connect each of the plurality of boosters to the plurality of low-voltage RGBW lights.

11. A landscape lighting system comprising:
a plurality of light strands, each light strand having a plurality of low-voltage RGBW lights;
a transformer for providing an initial power level, the transformer for connection to an exterior outlet or power source;
a plurality of boosters electrically connected to the transformer and for stepping up the initial power level of the transformer to a power level for the plurality of light strands, each of the plurality of boosters to be installed at a landscape element; and
a controller for providing color instructions to the plurality of boosters for each of the plurality of light strands.

12. The system of claim 11, further comprising a plurality of connectors for connecting the plurality of boosters to the transformer and for connecting the plurality of boosters to the plurality of low-voltage RGBW lights.

13. The system of claim 11, wherein each booster of the plurality of boosters comprises:
a box;
a light controller housed within the box, the light controller for controlling a color of individual light strands or individual bulbs of the plurality of light strands based on instructions received from the controller;
the booster housed within the box, the booster for stepping up the initial power level of the transformer to a power level for the plurality of light strands;
a connector at a first end of the box, the connector for connecting the booster to the transformer; and
a splitter at a second end of the box opposite the first end, the splitter for connecting the booster to one or more light strands of the plurality of light strands.

14. The system of claim 13, wherein the splitter comprises a 4-way splitter, with each leg of the 4-way splitter capable of connection to six (6) individual light strands of the plurality of light strands.

15. The system of claim 13, wherein each booster of the plurality of boosters further comprises a sensor for detecting weather conditions about the landscape lighting system.

16. The system of claim 11, wherein the controller comprises a locking mechanism preventing unauthorized adjustments to the landscape lighting system.

17. A method of powering a landscape lighting system, comprising:
connecting a transformer to a power source, the transformer for providing an initial power level ranging from about 12V AC to 15V AC;
connecting a plurality of boosters to the transformer;
stepping up the initial power level to an elevated, low-voltage power level, the elevated, low-voltage power level ranging from 30V DC to 50V DC;
powering one or more low-voltage lights with the elevated, low-voltage power level; and
individually controlling a color for each of the one or more of low-voltage lights.

18. The method of claim 17, further comprising installing the one or more low-voltage lights in a plurality of landscape elements.

19. The method of claim 17, further comprising installing the plurality of boosters in a plurality of landscape elements.

20. The method of claim 17, wherein stepping up the initial power level to an elevated, low-voltage power level comprises:
receiving an initial power level of 12V AC;
stepping up the 12V AC to 30V DC; and
providing 30V DC power one or more low-voltage lights.
